(19) United States
(12) Patent Application Publication
(10) Pub. No.: US 2023/0074680 A1
(43) Pub. Date: Mar. 9, 2023

(54) OBJECT RECOGNITION SYSTEM AND OBJECT RECOGNITION METHOD

(71) Applicant: SONY SEMICONDUCTOR SOLUTIONS CORPORATION, KANAGAWA (KR)

(72) Inventor: YUTO KOJIMA, KANAGAWA (JP)

(21) Appl. No.: 17/904,712

(22) PCT Filed: Feb. 5, 2021
(86) PCT No.: PCT/JP2021/004229

§ 371 Date: Aug. 19, 2022

(30) Foreign Application Priority Data
Feb. 27, 2020 (JP) 2020-032087

(51) Int. Cl. G06V 20/58; G06T 7/70; G06V 10/25; G06V 10/74; G06V 10/764; G01S 13/931; G05D 1/02

(52) U.S. Cl. CPC G06V 20/58; G06T 7/70; G06V 10/25; G06V 10/761; G06V 10/764; G01S 13/931; G05D 1/021; G06V 2201/07; G06T 2207/30252

(57) ABSTRACT

Provided are an object recognition system and an object recognition method capable of further shortening the processing time of object recognition.

In order to solve the above problems, the present disclosure provides an object recognition system including: a first detection device that generates image data having a predetermined imaging region; a second detection device that detects a specific region in which an object is highly likely to exist with respect to a detection region including at least a part of the predetermined imaging region; and an object recognition device that executes a recognition process for classifying an imaging target with respect to the image data, based on the specific region.

### TECHNICAL FIELD

The present disclosure relates to an object recognition system and an object recognition method.

### BACKGROUND ART

An object recognition system that recognizes an object from an image captured by an in-vehicle camera is generally known. In this object recognition device, a region is extracted from the entire image to perform object recognition. However, there are cases where a recognition process is performed even in an empty image region where an object does not obviously exist. Therefore, there is a possibility that the calculation time for object recognition will be longer.

### CITATION LIST

### Patent Literature

[PTL 1]

JP 2001-296357A

### SUMMARY

### Technical Problem

An object recognition system and an object recognition method are provided, which are capable of further shortening the processing time of object recognition.

### Solution to Problem

In order to solve the above problems, the present disclosure provides an object recognition system including: a first detection device that generates image data having a predetermined imaging region; a second detection device that detects a specific region in which an object is highly likely to exist with respect to a detection region including at least a part of the predetermined imaging region; and an object recognition device that executes a recognition process for classifying an imaging target with respect to the image data, based on the specific region.

The first detection device may be a camera that captures a visible image, and the second detection device may be a millimeter-wave radar that detects the specific region with millimeter waves.

The detection region may be distance image data generated by the second detection device.

The second detection device may detect the specific region, based on distance information in the distance image data.

The object recognition device may execute a recognition process on image data in a region corresponding to the specific region in the image data.

The object recognition device may execute the recognition process on an object recognition region corresponding to the specific region, based on information regarding an imaging range of the first detection device and information regarding an imaging range of the second detection device.

The object recognition device may execute the recognition process by a recognizer that receives image data as input and performs supervised learning using a category of an imaging target as teacher data.

the object recognition device recognizes at least an automobile among automobiles, motorcycles, and people.

The object recognition system may further include a vehicle control device that controls an automobile, based on a recognition result from the object recognition device.

The object recognition device may include: a camera position information conversion unit that generates a conversion formula that associates coordinates of the image data generated by the first detection device with coordinates of distance image data generated by the second detection device, based on information regarding an imaging range of the first detection device and information regarding an imaging range of the second detection device; a recognition region extraction unit that extracts an object recognition region corresponding to the specific region, based on the conversion formula; and a recognizer that receives image data in the object recognition region as input and outputs a category of an imaging target.

In order to solve the above problems, the present disclosure provides an object recognition method including: a first detection step of generating image data having a predetermined imaging region; a second detection step of detecting a specific region in which an object is highly likely to exist with respect to a detection region including at least a part of the predetermined imaging region; and an object recognition step of executing a recognition process for classifying an imaging target with respect to the image data based on the specific region.

The first detection step may be a step of capturing a visible image, and the second detection step may be a step of detecting a specific region in which an object is likely to exist with respect to the detection region with millimeter waves.

The detection region is distance image data having distance information.

The second detection step may involve detecting the specific region, based on the distance information in the distance image data.

The object recognition step may involve executing the recognition process on an object recognition region corresponding to the specific region, based on information regarding an imaging range in the first detection step and information regarding an imaging range in the second detection step.

The object recognition step may involve recognizing at least an automobile among automobiles, motorcycles, and people.

### BRIEF DESCRIPTION OF DRAWINGS

FIG. 1 is an explanatory diagram showing a configuration example of an object recognition system according to an embodiment of the present disclosure.

FIG. 2 is a diagram showing an example of image data obtained by an object recognition system.

FIG. 3 is a block diagram showing a detailed configuration of an object recognition system.

FIG. 4 is a diagram showing an arrangement example of each component of an object recognition system.

FIG. 5 is a diagram showing an example of an image output from an object recognition device to a display unit.

FIG. 6 is a diagram schematically showing a camera and a millimeter-wave radar arranged on the side surface of an automobile.

FIG. 7 is a diagram illustrating an angle when calculating Equation (1).

FIG. 8 is a diagram illustrating a distance between a camera and a millimeter-wave radar and an angle for calculation.

FIG. 9 is a flowchart showing an example of a recognition process of an object recognition system.

### DESCRIPTION OF EMBODIMENTS

Hereinafter, embodiments of the object recognition system and the object recognition method will be described with reference to the drawings. In the following, the main components of the object recognition system, the object recognition system, and the object recognition method will be mainly described, but the components and functions not shown or described in the object recognition system and the object recognition method may be present. The following description does not exclude components or functions that are not illustrated or described.

### EMBODIMENT

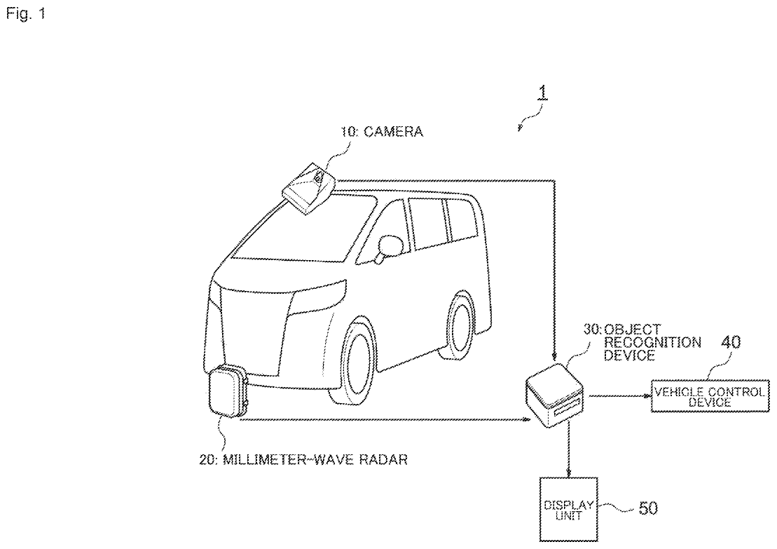

FIG. 1 is a diagram schematically showing a configuration example of an object recognition system 1 according to an embodiment of the present disclosure. The object recognition system 1 is, for example, a system that can be mounted on an automobile and can recognize a region of an object such as an automobile from an image.

The object recognition system 1 includes a camera 10, a millimeter-wave radar 20, an object recognition device 30, a vehicle control device 40, and a display unit 50. The camera 10 generates image data having a predetermined imaging region. The camera 10 is a camera that captures a visible image, and the imaging range of the camera 10 and the imaging range of the millimeter-wave radar 20 can be geometrically associated with each other. The camera 10 captures image data at predetermined intervals.

The millimeter-wave radar 20 is, for example, a 79 gigahertz (GHz) band millimeter-wave radar capable of wide-angle distance detection. The millimeter-wave radar 20 detects a specific region in which an object is likely to exist with respect to a detection region including at least a part of a predetermined imaging region. The camera 10 according to the present embodiment corresponds to a first detection device, and the millimeter-wave radar 20 according to the present embodiment corresponds to a second detection device.

The object recognition device 30 executes a recognition process for classifying an imaging target with respect to an image captured by the camera 10 based on a specific region. The vehicle control device 40 automatically brakes the vehicle based on the recognition result from the object recognition device 30.

The display unit 50 is, for example, a liquid crystal monitor. The display unit 50 displays an image output by the object recognition device 30.

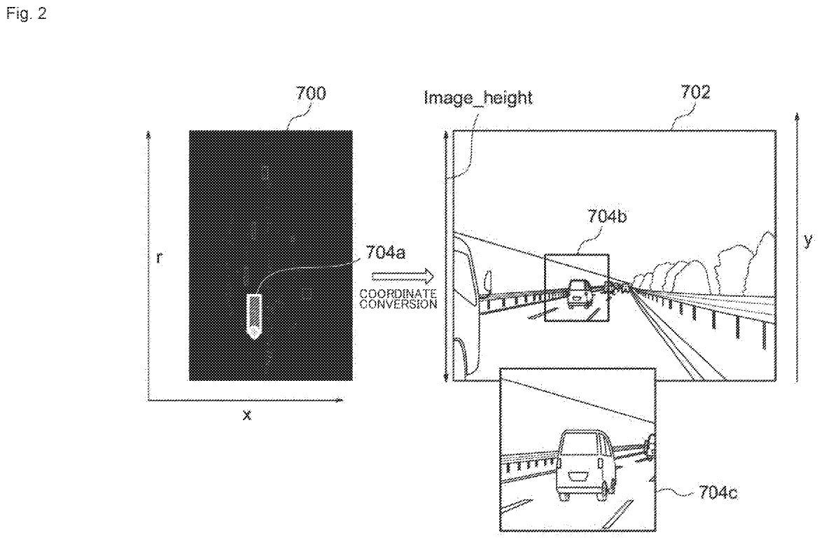

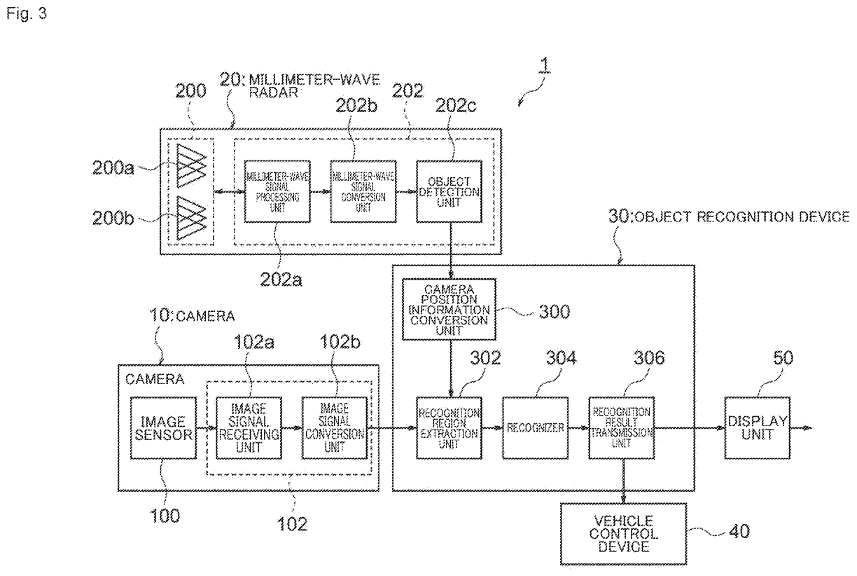

A detailed configuration of the object recognition system 1 will be described with reference to FIG. 2 and FIG. 3. FIG. 2 is a diagram showing an example of image data obtained by the object recognition system 1. An image 700 is an image generated by the millimeter-wave radar 20, and is a so-called bird's-eye view in which the vertical axis r indicates the distance and the horizontal axis X indicates the length in the horizontal direction. That is, this image 700 is a diagram configured by imitating a view of the front of the millimeter-wave radar 20 as viewed from above. A region 704a is a region corresponding to an automobile. Further, an image 702 is an image captured by the camera 10, and a recognition region 704b is a region corresponding to the region 704a. Here, y is defined as the coordinate in the vertical direction of the image 702, and Image_height is defined as the length in the vertical direction. An image 704c is image data obtained by cutting out the recognition region 704b.

FIG. 3 is a block diagram showing a detailed configuration of the object recognition system 1. As shown in FIG. 3, the camera 10 has an image sensor 100 and a camera back-end 102. The image sensor 100 is configured of a plurality of imaging elements, converts an optical image into image data, and outputs the image data.

The camera back-end 102 is configured of, for example, an interface (IF) substrate and a common substrate. The camera back-end 102 has an image signal receiving unit 102a configured of an interface substrate and an image signal conversion unit 102b configured of a common substrate. The image signal receiving unit 102a receives the image data generated by the image sensor 100 and outputs the image data to the image signal conversion unit 102b. The image signal conversion unit 102b performs noise reduction processing, reduction processing, and the like, and outputs the processed image data to the object recognition device 30.

The millimeter-wave radar 20 has a radar 200 and a radar back-end 202. The radar 200 has, for example, a transmitting antenna 200a and a receiving antenna 200b. The transmitting antenna 200a emits a 79 GH-band millimeter wave capable of wide-angle distance detection. The transmitting antenna 200a according to the present embodiment emits a 79 GH-band millimeter wave, but the present invention is not limited to this. For example, the transmitting antenna 200a may emit a millimeter wave having a frequency of 30 GHz to 300 GHz. The receiving antenna 200b converts the radio wave returned and reflected from an object into a millimeter-wave signal.

The radar back-end 202 is configured of, for example, an interface substrate and a common substrate. That is, the radar back-end 202 has a millimeter-wave signal processing unit 202a, a millimeter-wave signal conversion unit 202b, and an object detection unit 202c.

The millimeter-wave signal processing unit 202a generates a millimeter-wave signal with a synthesizer, and transmits radio waves from the transmitting antenna 200a.

The millimeter-wave signal conversion unit 202b calculates the distance value and the speed to the reflecting object for each output angle of the radio wave based on the millimeter-wave signal output by the receiving antenna 200b. In this way, for example, the millimeter-wave signal conversion unit 202b generates an image 700 in which the vertical axis indicates the distance r to the reflecting object and the horizontal axis indicates the distance orthogonal to the vertical axis. That is, the image 700 is distance image data having distance information.

The object detection unit 202c detects the object region 704a from the image 700 generated by the millimeter-wave signal conversion unit 202b. For example, the object detection unit 202c performs clustering by a labeling process using the distance value in the image 700, and detects the clustered object region as a specific region 704a having a high possibility of existence of an object.

The object recognition device 30 includes a camera position information conversion unit 300, a recognition region extraction unit 302, a recognizer 304, and a recognition result transmission unit 306.

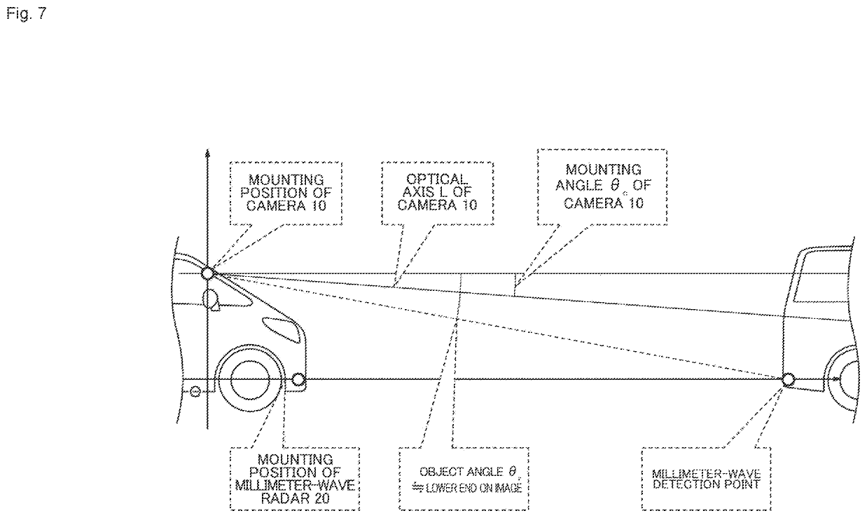

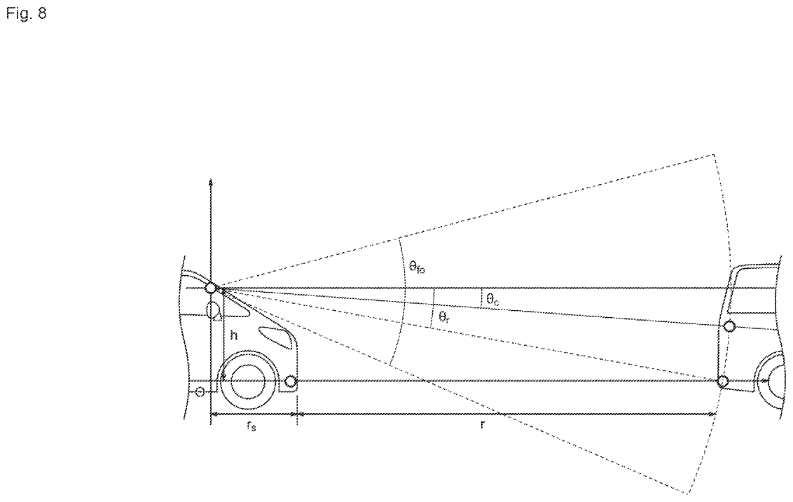

The camera position information conversion unit 300 can, for example, generate conversion-related information, for example, a conversion formula that associates the positional coordinates in the bird's-eye view image 700 generated by the millimeter-wave signal conversion unit 202b with the positional coordinates in the image 702 captured by the camera 10. The details of the conversion process of the camera position information conversion unit 300 will be described later with reference to FIGS. 7 and FIG. 8.

The recognition region extraction unit 302 extracts the recognition region 704b in the image 702 corresponding to the specific region 704a detected by the object detection unit 202c using the conversion information generated by the camera position information conversion unit 300. The recognition region extraction unit 302 can also enlarge or reduce the recognition region.

The recognizer 304 is, for example, a neural network that has undergone supervised learning. This recognizer is, for example, a neural network that receives an image as input data and performs learning using a category such as an automobile, a motorcycle, a bicycle, or a person as teacher data. As a result, the recognizer 304 takes, for example, the image 704c in the recognition region 704b as input data, and outputs a recognition signal having category information of the object in the image such as an automobile, a motorcycle, a bicycle, or a person to the vehicle control device 40. Further, the recognizer 304 can also output the reliability of the recognition result as a numerical value of 0.0 to 1.0. The higher the value, the higher the reliability of the recognition result.

Further, the recognizer 304 outputs a distance signal having distance information to the object in the image 704c to the vehicle control device 40 based on the specific region information in the bird's-eye view image corresponding to the recognition region. In this embodiment, the recognizer is configured by a neural network, but the present invention is not limited to this. For example, the type of the recognizer is not particularly limited as long as the recognizer receives an image as input and outputs the category of the image.

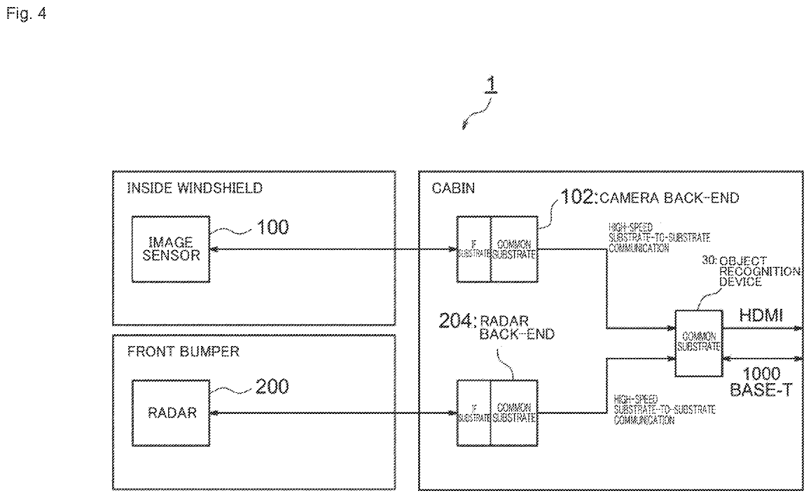

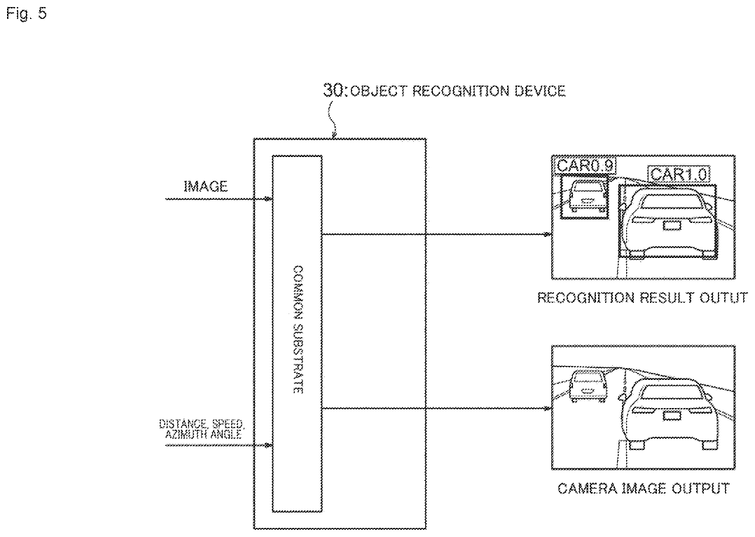

FIG. 4 is a diagram showing an arrangement example of each component of the object recognition system 1. As shown in FIG. 5, the image sensor 100 of the camera 10 is arranged inside the windshield of the automobile, and the radar 200 of the millimeter-wave radar 20 is arranged in the front bumper. On the other hand, the common substrate constituting the camera back-end 102, the radar back-end 204, the object recognition device 30, and the like are arranged in the cabin of the automobile. Further, the common substrate constituting the camera back-end 102, the radar back-end 204, and the object recognition device 30 performs input/output of signals by high-speed substrate-to-substrate communication.

FIG. 5 is a diagram showing an example of an image output from the object recognition device 30 to the display unit 50. As shown in FIG. 5, the object recognition device 30 outputs a camera image and an image showing a recognition result for the camera image to the display unit 50. For example, in the image showing the recognition result, a frame showing the recognition region, the recognition result, and the reliability are displayed.

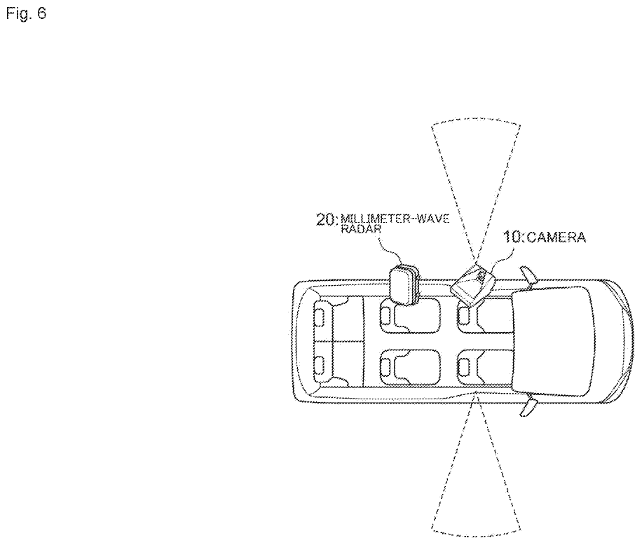

FIG. 6 is a diagram schematically showing the camera 10 and the millimeter-wave radar 20 arranged on the side surface of an automobile. As shown in FIG. 5, it is also possible to arrange the camera 10 and the millimeter-wave radar 20 on the side surface of the automobile to recognize an object in the side surface direction.

Here, the relationship between the vertical coordinate r of the image 700 and the vertical coordinate y in the image 702 will be described with reference to FIG. 7 and FIG. 8 along with FIG. 2. Equation (1) is an equation showing the relationship between the vertical coordinate r of the image 700 and the vertical coordinate y in the image 702.

FIG. 7 is a diagram illustrating an angle when calculating Equation (1) from information such as the mounting position of the camera 10 and the mounting position of the millimeter-wave radar 20. That is, L is defined as the optical axis of the camera 10, θc is defined as the mounting angle of the camera 10, and θr is defined as the object angle.

FIG. 8 is a diagram illustrating a distance between the camera 10 and the millimeter-wave radar 20 and an angle for calculation. That is, hc is defined as the vertical distance between the camera 10 and the millimeter-wave radar 20, and rs is defined as the horizontal distance between the camera 10 and the millimeter-wave radar 20. Further, the vertical imaging range of the camera 10 is indicated by an angle θfov. In such an arrangement relationship, the vertical coordinate r of the image 700 and the vertical coordinate y in the image 702 can be calculated by Equation (1). That is, it is possible to associate the vertical coordinate of the image 700 with the vertical coordinate of the image 702 by Equation (1). Similarly, the horizontal coordinates can be calculated by the relationship between the angle θfov and the distance r indicating the horizontal imaging range of the camera 10.

$$\begin{matrix}[ Math . 1 ] & \\ y = ( image\_height ) \times ( 0.5 + \frac{{tan}^{- 1} \frac{{h}_{c}}{r + {r}_{s}} - {θ}_{c}}{{θ}_{fov}} ) & ( 1 )\end{matrix}$$

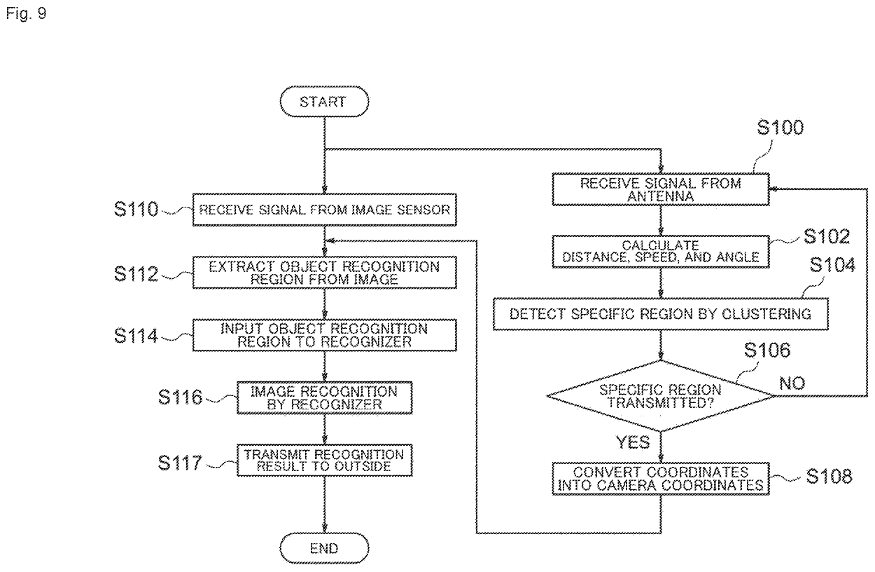

FIG. 9 is a flowchart showing an example of a recognition process of the object recognition system 1.

First, the millimeter-wave signal conversion unit 202b receives the millimeter-wave signal output by the receiving antenna 200b (step S100), and the millimeter-wave signal conversion unit 202b calculates a distance value and a speed to a reflecting object for each radio wave output angle (step S102). Subsequently, a distance image is generated in which the vertical axis indicates the distance to the reflecting object and the horizontal axis indicates the distance orthogonal to the vertical axis.

Next, the object detection unit 202c detects the object region 704a from within the distance image. For example, the object detection unit 202c performs clustering by labeling processing using the distance value in the distance image, and detects the clustered object region as a specific region having a high possibility of existence of an object (step S104). Subsequently, the object detection unit 202c determines whether or not to transmit the detected specific region to the object recognition device 30 (step S106). For example, if the specific region is equal to or larger than a predetermined area, it is determined that the specific region is to be transmitted to the object recognition device 30 (YES in step S106), and the coordinate information of the specific region is output to the recognition region extraction unit 302.

On the other hand, when it is determined that the specific region is not to be transmitted to the object recognition device 30 (NO in step S106), the process from step S100 is repeated. The recognition region extraction unit 302 converts the coordinate information of the specific region into the coordinates of the image of the camera 10 according to Equation (1) (step S108), receives the camera image from the camera 10 (step S110), and extracts the object recognition region from the received image (step S112). Subsequently, the recognition region extraction unit 302 outputs the object recognition region to the recognizer 304 (step S114).

Next, the recognizer 304 performs a recognition process on the camera image in the object recognition region (step S116). Then, the recognizer 304 outputs the recognition result to the vehicle control device 40 and the display unit 50, and ends the process.

As described above, according to the present embodiment, the object recognition device 30 executes the recognition process on the region 704b of the camera image corresponding to the object recognition region 704a recognized by the millimeter-wave radar 20. As a result, the recognition region 704b is limited to the region where the object is likely to exist, so that the processing speed of the object recognition device 30 is further shortened.

The present technology can have the following configurations.

(1) An object recognition system including: a first detection device that generates image data having a predetermined imaging region; a second detection device that detects a specific region in which an object is highly likely to exist with respect to a detection region including at least a part of the predetermined imaging region; and an object recognition device that executes a recognition process for classifying an imaging target with respect to the image data, based on the specific region.

(2) The object recognition system according to (1), wherein the first detection device is a camera that captures a visible image, and the second detection device is a millimeter-wave radar that detects the specific region with millimeter waves.

(3) The object recognition system according to (2), wherein the detection region is distance image data generated by the second detection device.

(4) The object recognition system according to (3), wherein the second detection device detects the specific region, based on distance information in the distance image data.

(5) The object recognition system according to any one of (1) to (4), wherein the object recognition device executes a recognition process on image data in a region corresponding to the specific region in the image data.

(6) The object recognition system according to any one of (1) to (5), wherein the object recognition device executes the recognition process on an object recognition region corresponding to the specific region, based on information regarding an imaging range of the first detection device and information regarding an imaging range of the second detection device.

(7) The object recognition system according to any one of (1) to (6), wherein the object recognition device executes the recognition process by a recognizer that receives image data as input and performs supervised learning using a category of an imaging target as teacher data.

(8) The object recognition system according to any one of (1) to (7), wherein the object recognition device recognizes at least an automobile among automobiles, motorcycles, and people.

(9 The object recognition system according to any one of (1) to (8), further comprising: a vehicle control device that controls an automobile, based on a recognition result from the object recognition device.

(10) The object recognition system according to any one of (1) to (9), wherein the object recognition device includes: a camera position information conversion unit that generates a conversion formula that associates coordinates of the image data generated by the first detection device with coordinates of distance image data generated by the second detection device, based on information regarding an imaging range of the first detection device and information regarding an imaging range of the second detection device; a recognition region extraction unit that extracts an object recognition region corresponding to the specific region, based on the conversion formula; and a recognizer that receives image data in the object recognition region as input and outputs a category of an imaging target.

(11) An object recognition method including: a first detection step of generating image data having a predetermined imaging region; a second detection step of detecting a specific region in which an object is highly likely to exist with respect to a detection region including at least a part of the predetermined imaging region; and an object recognition step of executing a recognition process for classifying an imaging target with respect to the image data, based on the specific region.

(12) The object recognition method according to (11), wherein the first detection step is a step of capturing a visible image, and the second detection step is a step of detecting a specific region in which an object is highly likely to exist with respect to the detection region with millimeter waves.

(13) The object recognition method according to (12), wherein the detection region is distance image data having distance information.

(14) The object recognition method according to (13), wherein the second detection step involves detecting the specific region, based on the distance information in the distance image data.

(15) The object recognition method according to any one of (11) to (14), wherein the object recognition step involves executing a recognition process on image data in a region corresponding to the specific region in the image data.

(16) The object recognition method according to any one of (11) to (15), wherein the object recognition step involves executing the recognition process on an object recognition region corresponding to the specific region, based on information regarding an imaging range in the first detection step and information regarding an imaging range in the second detection step.

(17) The object recognition method according to any one of (11) to (16), wherein the object recognition step involves executing the recognition process by a recognizer that receives image data as input and performs supervised learning using a category of an imaging target as teacher data.

(18) The object recognition method according to any one of (11) to (16), wherein the object recognition step involves recognizing at least an automobile among automobiles, motorcycles, and people.

### REFERENCE SIGNS LIST

1 Object recognition system

10 Camera

10 Millimeter-wave radar

30 Object recognition device

40 Vehicle control device

300 Camera position information conversion unit

302 Recognition region extraction unit

304 Recognizer

1. An object recognition system comprising:
a first detection device that generates image data having a predetermined imaging region;
a second detection device that detects a specific region in which an object is highly likely to exist with respect to a detection region including at least a part of the predetermined imaging region; and
an object recognition device that executes a recognition process for classifying an imaging target with respect to the image data, based on the specific region.

2. The object recognition system according to claim 1, wherein
the first detection device is a camera that captures a visible image, and the second detection device is a millimeter-wave radar that detects the specific region with millimeter waves.

3. The object recognition system according to claim 2, wherein
the detection region is distance image data generated by the second detection device.

4. The object recognition system according to claim 3, wherein
the second detection device detects the specific region, based on distance information in the distance image data.

5. The object recognition system according to claim 1, wherein
the object recognition device executes a recognition process on image data in a region corresponding to the specific region in the image data.

6. The object recognition system according to claim 1, wherein
the object recognition device executes the recognition process on an object recognition region corresponding to the specific region, based on information regarding an imaging range of the first detection device and information regarding an imaging range of the second detection device.

7. The object recognition system according to claim 1, wherein
the object recognition device executes the recognition process by a recognizer that receives image data as input and performs supervised learning using a category of an imaging target as teacher data.

8. The object recognition system according to claim 1, wherein
the object recognition device recognizes at least an automobile among automobiles, motorcycles, and people.

9. The object recognition system according to claim 1, further comprising:
a vehicle control device that controls an automobile, based on a recognition result from the object recognition device.

10. The object recognition system according to claim 1, wherein
the object recognition device includes:
a camera position information conversion unit that generates a conversion formula that associates coordinates of the image data generated by the first detection device with coordinates of distance image data generated by the second detection device, based on information regarding an imaging range of the first detection device and information regarding an imaging range of the second detection device;
a recognition region extraction unit that extracts an object recognition region corresponding to the specific region, based on the conversion formula; and
a recognizer that receives image data in the object recognition region as input and outputs a category of an imaging target.

11. An object recognition method comprising:
a first detection step of generating image data having a predetermined imaging region;
a second detection step of detecting a specific region in which an object is highly likely to exist with respect to a detection region including at least a part of the predetermined imaging region; and
an object recognition step of executing a recognition process for classifying an imaging target with respect to the image data, based on the specific region.

12. The object recognition method according to claim 11, wherein
the first detection step is a step of capturing a visible image, and the second detection step is a step of detecting a specific region in which an object is highly likely to exist with respect to the detection region with millimeter waves.

13. The object recognition method according to claim 12, wherein
the detection region is distance image data having distance information.

14. The object recognition method according to claim 13, wherein
the second detection step involves detecting the specific region, based on the distance information in the distance image data.

15. The object recognition method according to claim 11, wherein
the object recognition step involves executing a recognition process on image data in a region corresponding to the specific region in the image data.

16. The object recognition method according to claim 11, wherein
the object recognition step involves executing the recognition process on an object recognition region corresponding to the specific region, based on information regarding an imaging range in the first detection step and information regarding an imaging range in the second detection step.

17. The object recognition method according to claim 11, wherein
the object recognition step involves executing the recognition process by a recognizer that receives image data as input and performs supervised learning using a category of an imaging target as teacher data.

18. The object recognition method according to claim 11, wherein
the object recognition step involves recognizing at least an automobile among automobiles, motorcycles, and people.
